(19) United States
(12) Patent Application Publication
(10) Pub. No.: US 2004/0184615 A1
(43) Pub. Date: Sep. 23, 2004

(54) Systems and methods for arbitrating quantum cryptographic shared secrets

(76) Inventors: Brig Barnum Elliott, Arlington, MA (US); David Spencer Pearson, Bennington, VT (US)

Correspondence Address: VERIZON CORPORATE SERVICES GROUP INC., C/O CHRISTIAN R. ANDERSEN, 600 HIDDEN RIDGE DRIVE, MAILCODE HQEO3H14, IRVING, TX, 75038, US

(21) Appl. No.: 10/394,874

(22) Filed: Mar. 21, 2003

(51) Int. Cl. H04L 9/00

(52) U.S. Cl. 380/283

(57) ABSTRACT

A quantum cryptographic key distribution system (100) includes a first quantum cryptographic device (105b) and a second quantum cryptographic device (105a). The first quantum cryptographic device (105b) is designated as a slave device and stores shared secret bits. The second quantum cryptographic device (105a) is designated as a master device and selects a block of the shared secret bits and notifies the slave device of the selected block of the shared secret bits for using in cryptographically protecting data sent between the first (105b) and second (105a) quantum cryptographic devices.

### RELATED APPLICATIONS

The present application is related to U.S. patent application Ser. No. 09/943,709 (Attorney Docket No. 01-4015), entitled “Systems and Methods for Path Set-up in a Quantum Key Distribution Network” and filed Aug. 31, 2001; U.S. patent application Ser. No. 09/944,328 (Attorney Docket No. 00-4069), entitled “Quantum Cryptographic Key Distribution Networks with Untrusted Switches” and filed Aug. 31, 2001; and U.S. patent application Ser. No. 10/271,103, entitled “Systems and Methods for Framing Quantum Cryptographic Links” and filed Oct. 15, 2002, the disclosures of which are incorporated by reference herein in their entirety.

### GOVERNMENT CONTRACT

The U.S. Government has a paid-up license in this invention and the right in limited circumstances to require the patent owner to license others on reasonable terms as provided for by the terms of Contract No. F30602-01-C-0170, awarded by the Defense Advanced Research Projects Agency (DARPA).

### FIELD OF THE INVENTION

The present invention relates generally to cryptographic systems and, more particularly, to systems and methods for arbitrating shared secrets in quantum cryptographic systems.

### BACKGROUND OF THE INVENTION

Within the field of cryptography, it is well recognized that the strength of any cryptographic system depends, among other things, on the key distribution technique employed. For conventional encryption systems to be effective, such as a symmetric key system, two communicating parties must share the same key, and that key must be protected from access by others. The key must, therefore, be distributed to each of the parties. For a party, Bob, to decrypt ciphertext encrypted by a party, Alice, Alice or a third party must distribute a copy of the key to Bob. This distribution process can be implemented in a number of conventional ways including the following: 1) Alice can select a key and physically deliver the key to Bob; 2) A third party can select a key and physically deliver the key to Alice and Bob; 3) If Alice and Bob both have an encrypted connection to a third party, the third party can deliver a key on the encrypted links to Alice and Bob; 4) If Alice and Bob have previously used an old key, Alice can transmit a new key to Bob by encrypting the new key with the old; and 5) Alice and Bob may agree on a shared key via a one-way mathematical algorithm, such as Diffie-Helman key agreement. All of these distribution methods are vulnerable to interception of the distributed key by an eavesdropper Eve, or by Eve “cracking” the supposedly one-way algorithm. Eve can eavesdrop and intercept or copy a distributed key and then subsequently decrypt any intercepted ciphertext that is sent between Bob and Alice. In conventional cryptographic systems, this eavesdropping may go undetected, with the result being that any ciphertext sent between Bob and Alice is compromised.

To combat these inherent deficiencies in the key distribution process, researchers have developed a key distribution technique called quantum cryptography. Quantum cryptography employs quantum systems and applicable fundamental principles of physics to ensure the security of distributed keys. Heisenberg's uncertainty principle mandates that any attempt to observe the state of a quantum system will necessarily induce a change in the state of the quantum system. Thus, when very low levels of matter or energy, such as individual photons, are used to distribute keys, the techniques of quantum cryptography permit the key distributor and receiver to determine whether any eavesdropping has occurred during the key distribution. Quantum cryptography, therefore, prevents an eavesdropper, like Eve, from copying or intercepting a key that has been distributed from Alice to Bob without a significant probability of Bob's or Alice's discovery of the eavesdropping.

### SUMMARY OF THE INVENTION

Systems and methods consistent with the present invention arbitrate the allocation of shared secret symbols resulting from quantum cryptographic key distribution (QKD) between QKD endpoints in a QKD system. In a quantum cryptographic system, where multiple distributed entities may attempt to access shared secret bits, contention and deadlocks may arise. For example, if a first client (A1) in a first QKD endpoint and a second client (B1) in a second QKD endpoint are both attempting to set up a new security association at the same time, using shared secret symbols derived using quantum cryptographic techniques, then the result should be security associations using two distinct sets of symbols. However, it may happen that client A1 decides to use block “N” of secret bits, and client B 1, at the same time, makes exactly the same choice. Then, when client A1 tries to inform client B 1 that it wants to set up a new security association using block “N,” client B 1 will deny the request because its own local copy of block “N” is already in use for the security association that is being set up.

Client A1 may then decide not to use block “N” after all, but may try to use block “N+1” instead. Unfortunately, client B1 may also make exactly the same decision. Thus, A1 and B1 may deadlock on a second attempt to agree on shared bits. Clients at distributed points in a QKD system may, thus, seek to use shared secrets in such a way as to lead to serious contention and deadlock problems. Systems and methods consistent with the invention, therefore, alleviate contention and deadlock problems that may result from clients at QKD endpoints vying for the same shared secret bits by implementing processes for arbitrating access to the shared secret bits.

In accordance with the purpose of the invention as embodied and broadly described herein, a method of arbitrating selection of shared secret bits between multiple quantum cryptographic key distribution (QKD) devices includes designating one of the QKD devices as a master device and at least one of the other of the multiple QKD devices as a slave device. The method further includes selecting a block of the shared secret bits at the master device and notifying the slave device of the selected block of the shared secret bits.

In another implementation consistent with the present invention, a method of allocating shared secret data at multiple devices includes selecting a block of the shared secret data at a first of the multiple devices and sending an identifier of the selected block to a second of the multiple devices. The method further includes allocating the selected block at the first and second of the multiple devices for use in cryptographically protecting data sent between the first and second of the multiple devices.

In a further implementation consistent with the present invention, a data structure encoded on a computer readable medium includes first data comprising a first block of secret bits transmitted via one or more quantum cryptographic techniques and second data comprising a first label identifying the first block of secret bits. The data structure further includes third data comprising a second block of secret bits transmitted via the one or more quantum cryptographic techniques and fourth data comprising a second label identifying the second block of secret bits.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 illustrates an exemplary network in which systems and methods, consistent with the present invention, may be implemented;

FIG. 2 illustrates an exemplary configuration of a QKD endpoint of FIG. 1 consistent with the present invention;

FIG. 3 illustrates exemplary components of the quantum cryptographic transceiver of FIG. 2 consistent with the present invention;

FIG. 4 illustrates an exemplary QKD endpoint functional block diagram consistent with the present invention;

FIG. 5 illustrates an exemplary high-level system diagram of QKD endpoints consistent with the present invention;

FIG. 6 illustrates an exemplary block of the blocks of FIG. 5 consistent with the present invention;

FIG. 7 is a flow chart that illustrates an exemplary master initiated shared secret arbitration process consistent with the present invention;

FIG. 8 is an exemplary graphical representation of the process of FIG. 7 consistent with the present invention;

FIG. 9 is a flow chart that illustrates an exemplary slave initiated shared secret arbitration process consistent with the present invention; and

FIG. 10 illustrates an exemplary graphical representation of the process of FIG. 9 consistent with the present invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims.

Systems and methods, consistent with the present invention, arbitrate the allocation of secret bits shared by QKD endpoints by, for example, designating one of the QKD endpoints as a “master” endpoint. The designated “master” endpoint may represent a centralized authority for regulating the allocation of shared secret bits, derived from quantum cryptographic techniques, to one or more other QKD endpoints.

### Exemplary Network

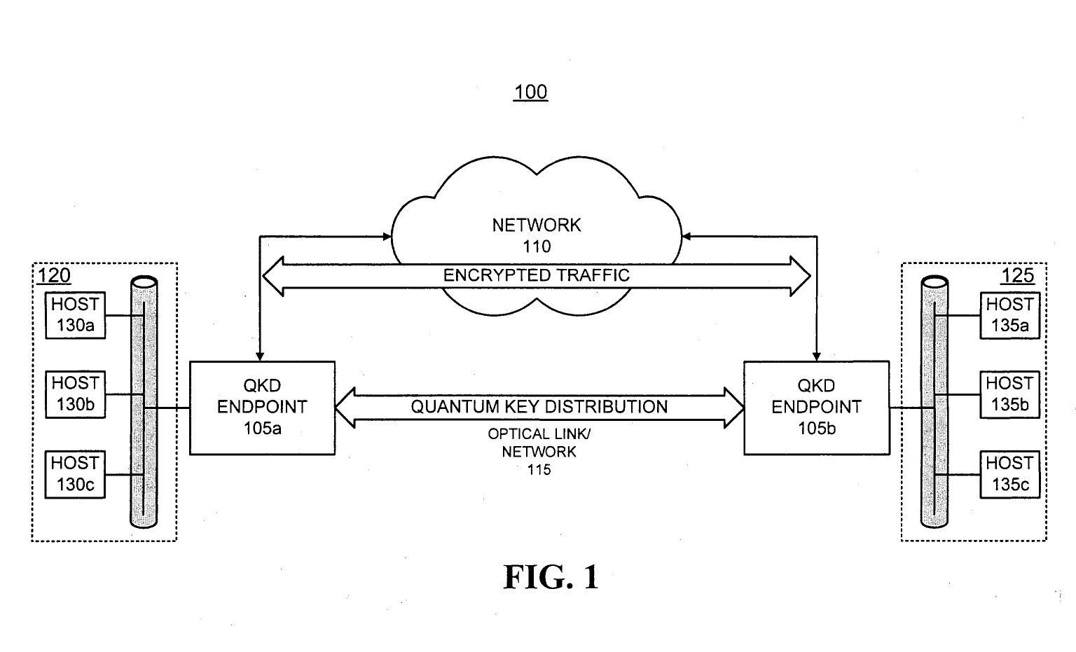

FIG. 1 illustrates an exemplary network 100 in which systems and methods consistent with the present invention that distribute encryption keys via quantum cryptographic mechanisms can be implemented. Network 100 may include QKD endpoints 105a and 105b connected via a network 110 and an optical link/network 115. QKD endpoints 105a and 105b may each include a host or a server. QKD endpoints 105a and 105b may further connect to local area networks (LANs) 120 or 125. LANs 120 and 125 may further connect hosts 130a-130c and 135a-135c, respectively.

Network 110 can include one or more networks of any type, including a Public Land Mobile Network (PLMN), Public Switched Telephone Network (PSTN), LAN, metropolitan area network (MAN), wide area network (WAN), Internet, or Intranet. Network 110 may also include a dedicated fiber link or a dedicated freespace optical or radio link. The one or more PLMNs may further include packet-switched sub-networks, such as, for example, General Packet Radio Service (GPRS), Cellular Digital Packet Data (CDPD), and Mobile IP sub-networks.

Optical link/network 115 may include a link that carries light throughout the electromagnetic spectrum, including light in the human visible spectrum and light beyond the human-visible spectrum, such as, for example, infrared or ultraviolet light. The link may include, for example, a conventional optical fiber. Alternatively, the link may include a free-space optical path, such as, for example, a path through the atmosphere or outer space, or even through water or other transparent media. As another alternative, the link may include a hollow optical fiber that may be lined with photonic band-gap material.

Alternatively, optical link/network 115 may include a QKD network that includes one or more QKD switches (not shown) for distributing encryption keys between a source QKD endpoint (e.g., QKD endpoint 105a) and a destination QKD endpoint (e.g., QKD endpoint 105b). Such a QKD network may include the QKD network described in U.S. patent application Ser. No. 09/943,709 (Attorney Docket No. 01-4015), entitled “Systems and Methods for Path Set-up in a Quantum Key Distribution Network,” and U.S. patent application Ser. No. 09/944,328 (Attorney Docket No. 00-4069), entitled “Quantum Cryptographic Key Distribution Networks with Untrusted Switches.”

QKD endpoints 105 may distribute encryption key symbols via optical link/network 115. Subsequent to quantum key distribution via optical link/network 115, QKD endpoint 105a and QKD endpoint 105b may encrypt traffic using the distributed key(s) and transmit the traffic via network 110. Though only two QKD endpoints 105 are shown, multiple QKD endpoints 105 (i.e., more than two) may be present in network 100.

It will be appreciated that the number of components illustrated in FIG. 1 are provided for explanatory purposes only. A typical network may include more or fewer components than are illustrated in FIG. 1.

### Exemplary QKD Endpoint

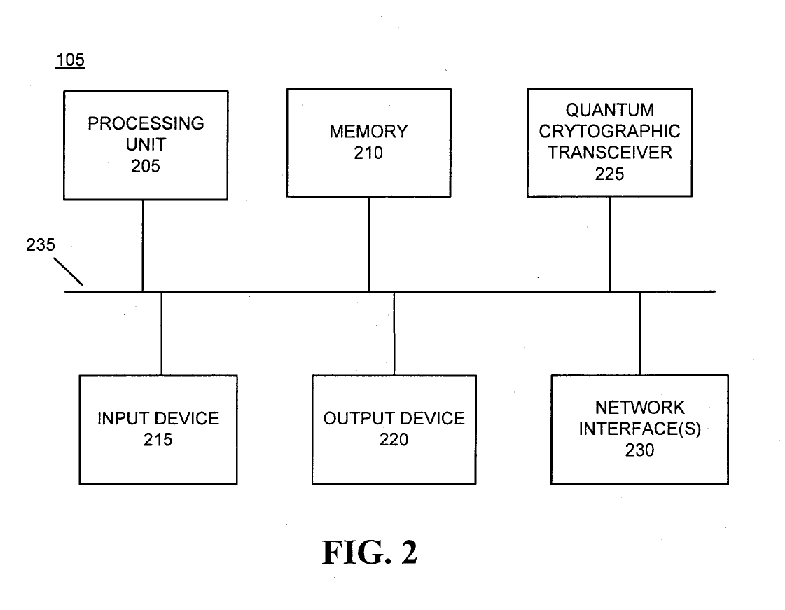

FIG. 2 illustrates exemplary components of a QKD endpoint 105 consistent with the present invention. QKD endpoint 105 may include a processing unit 205, a memory 210, an input device 215, an output device 220, a quantum cryptographic transceiver 225, a network interface(s) 230 and a bus 235. Processing unit 205 may perform all data processing functions for inputting, outputting, and processing of QKD endpoint data. Memory 210 may include Random Access Memory (RAM) that provides temporary working storage of data and instructions for use by processing unit 205 in performing processing functions. Memory 210 may additionally include Read Only Memory (ROM) that provides permanent or semi-permanent storage of data and instructions for use by processing unit 205. Memory 210 can also include non-volatile memory, such as an electrically erasable programmable read only memory (EPROM) that stores data for use by processing unit 205. Memory 210 can further include a large-capacity storage device(s), such as a magnetic and/or optical recording medium and its corresponding drive.

Input device 215 permits entry of data into QKD endpoint 105 and may include a user interface (not shown). Output device 220 permits the output of data in video, audio, or hard copy format. Quantum cryptographic transceiver 225 may include mechanisms for transmitting and receiving encryption keys using quantum cryptographic techniques. Network interface(s) 230 may interconnect QKD endpoint 105 with network 110. Bus 235 interconnects the various components of QKD endpoint 105 to permit the components to communicate with one another.

### Exemplary Quantum Cryptographic Transceiver

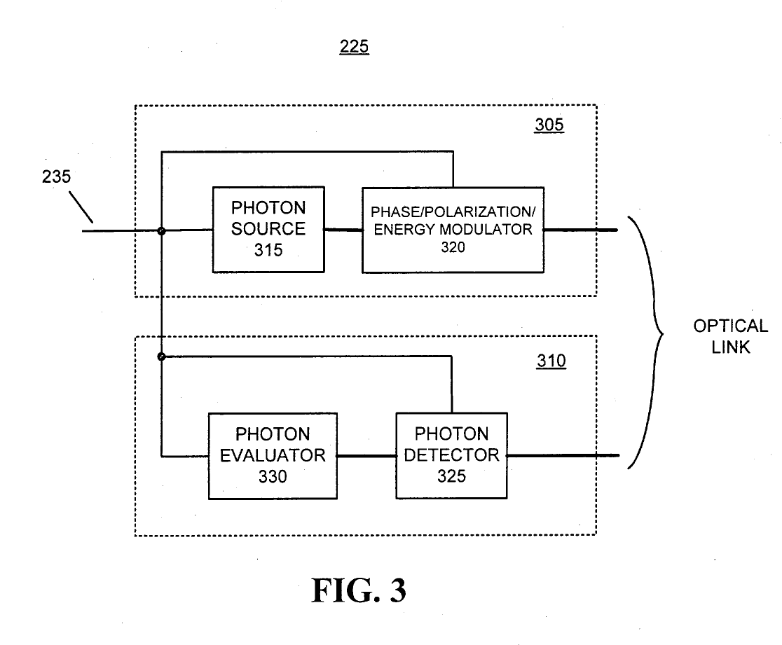

FIG. 3 illustrates exemplary components of quantum cryptographic transceiver 225 of a QKD endpoint 105 consistent with the present invention. Quantum cryptographic transceiver 225 may include a QKD transmitter 305 and a QKD receiver 310. QKD transmitter 305 may include a photon source 315 and a phase/polarization/energy modulator 320. Photon source 315 can include, for example, a conventional laser. Photon source 315 may produce photons according to instructions provided by processing unit 205. Photon source 315 may produce photons of light with wavelengths throughout the electromagnetic spectrum, including light in the human visible spectrum and light beyond the human-visible spectrum, such as, for example, infrared or ultraviolet light. Phase/polarization/energy modulator 320 can include, for example, conventional Mach-Zehnder interferometers. Phase/polarization/energy modulator 320 may encode outgoing photons from the photon source according to commands received from processing unit 205 for transmission across an optical link, such as link 115.

QKD receiver 310 may include a photon detector 325 and a photon evaluator 330. Photon detector 325 can include, for example, conventional avalanche photo detectors (APDs) or conventional photo-multiplier tubes (PMTs). Photon detector 325 can also include cryogenically cooled detectors that sense energy via changes in detector temperature or electrical resistivity as photons strike the detector apparatus. Photon detector 325 can detect photons received across the optical link. Photon evaluator 330 can include conventional circuitry for processing and evaluating output signals from photon detector 325 in accordance with quantum cryptographic techniques.

### Exemplary QKD Endpoint Functional Block Diagram

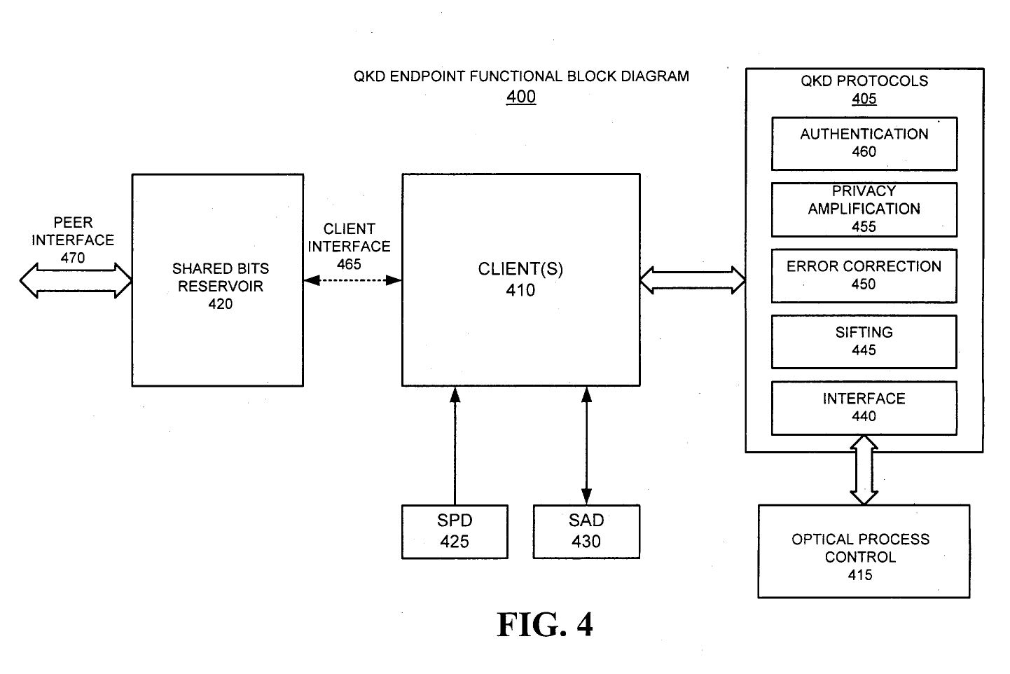

FIG. 4 illustrates an exemplary functional block diagram 400 of a QKD endpoint 105 consistent with the present invention. Functional block diagram 400 may include QKD protocols 405, client(s) 410, optical process control 415, shared bits reservoir 420, a security policy database (SPD) 425, and a security association database (SAD) 430. QKD protocols 405 may further an interface layer 440, a sifting layer 445, an error correction layer 450, a privacy amplification layer 455 and an authentication layer 460. The interface layer 440 may include protocols for deriving QKD symbols from photons transmitted via QKD link/network 115 and received at a quantum cryptographic transceiver 225 of a QKD endpoint 105. Values of the QKD symbols (e.g., high or low symbol values) may be interpreted at layer 440 by the polarization, phase or energy states of incoming photons. Interface layer 440 may measure the polarization, phase or energy state of each received photon and interpret the measurement as corresponding to whether a first detector fired, a second detector fired, both first and second detectors fired, neither detectors fired, or any other relevant measurements such as the number of photons detected.

Sifting layer 445 may implement protocols for discarding or “sifting” certain of the raw symbols produced by layer 440. The protocols of sifting layer 445 may exchange basis information between the parties to a QKD symbol exchange. As an example, when QKD endpoint 105a receives polarized photons from QKD endpoint 105b, sifting layer 445 may measure the polarization of each photon along either a rectilinear or diagonal basis with equal probability. Sifting layer 445 may record the basis that is used for measuring the polarization of each photon. Sifting layer 445 may inform QKD endpoint 105b the basis chosen for measuring the polarization of each photon. QKD endpoint 105b may then, via the protocols of sifting layer 445, inform QKD endpoint 105a, whether it has made the polarization measurement along the correct basis. QKD endpoint 105a and 105b may then “sift” or discard all polarization measurements in which QKD endpoint 105a has made the measurement along the wrong basis and keep only the measurements in which QKD endpoint 105a has made the measurement along the correct basis. For example, if QKD endpoint 105b transmits a photon with a symbol encoded as a 0° polarization and if QKD endpoint 105a measures the received photon via a diagonal basis (45°-135°), then QKD endpoint 105b and 105a will discard this symbol value since QKD endpoint 105a has made the measurement along the incorrect basis.

Error correction layer 450 may implement protocols for correcting errors that may be induced in transmitted photons due to, for example, the intrinsic noise of the quantum channel. Layer 450 may implement parity or cascade checking, convolutional encoding or other known error correction processes. Error correction layer 450 may additionally implement protocols for determining whether eavesdropping has occurred on the quantum channel. Errors in the states (e.g., polarization, phase or energy) of received photons may occur if an eavesdropper is eavesdropping on the quantum channel. To determine whether eavesdropping has occurred during transmission of a sequence of photons, QKD endpoint 105a and QKD endpoint 105b may randomly choose a subset of photons from the sequence of photons that have been transmitted and measured on the same basis. For each of the photons of the chosen subset, QKD endpoint 105b publicly announces its measurement result to QKD endpoint 105a. QKD endpoint 105a then informs QKD endpoint 105b whether its result is the same as what was originally sent. QKD endpoint 105a and 105b both may then compute the error rate of the subset of photons. If the computed error rate is higher than an agreed upon tolerable error rate (typically about 15%), then QKD endpoint 105a and 105b may infer that substantial eavesdropping has occurred. They may then discard the current polarization data and start over with a new sequence of photons.

Privacy amplification layer 455 may implement protocols for reducing error-corrected symbols received from layer 450 to a small set of derived symbols (e.g., bits) to reduce an eavsdropper's knowledge of the key. If, subsequent to sifting and error correction, QKD endpoint 105a and 105b have adopted n symbols as secret symbols, then privacy amplification layer 455 may compress the n symbols using, for example, a hash function. QKD endpoint 105a and 105b may agree upon a publicly chosen hash function f and take K=f(n symbols) as the shared r-symbol length key K. The hash function randomly redistributes the n symbols such that a small change in symbols produces a large change in the hash value. Thus, even if an eavesdropper determines a number of symbols of the transmitted key through eavesdropping, and also knows the hash function f, they still will be left with very little knowledge regarding the content of the hashed r-symbol key K.

Authentication layer 460 may implement protocols for authenticating transmissions between QKD endpoint 105a and 105b via network 110. Such protocols may include any conventional authentication mechanisms known to one skilled in the art (e.g., message authentication codes (MACs)).

Client(s) 410 may include one or more clients that perform various QKD endpoint functions. In one implementation, client(s) 410 may include an Internet Key Exchange (IKE) client that implement key exchange protocols and algorithms. In another implementation, client(s) 410 may include one or more pseudo-random number generators that use deterministic functions that accept secret random numbers as seed values to produce pseudo-random number sequences. Client(s) 410 may retrieve, via client interface 465, secret bit symbols from shared bits reservoir 420 and provide the retrieved symbols, via peer interface 470, to a client associated with another QKD endpoint. Client interface 465 may be internal to a QKD endpoint 105 (e.g., shared via shared memory or local network link). Peer interface 470 may include an external communications channel through network 110.

Optical process control 415 may control opto-electronics of quantum cryptographic transceiver 225. In exemplary embodiments that use framing, optical process control 415 may impose the framing on the QKD link. Optical process control 415 may continuously transmit and receive frames of QKD symbols and report the results to QKD protocol suite 405. Shared bits reservoir 420 may reside in memory 210 and may store the secret encryption key symbols (i.e., “bits”) derived via QKD protocols 405. Shared bits reservoir 420 may, in some implementations, comprise multiple shared bits reservoirs, one for each quantum cryptographic peer.

SPD 425 may include a database, together with algorithms, that classify received data units to determine which data belong in which security associations. This may be accomplished by matching various fields in the received data units with rule sets in the database. SAD 430 may include a database, together with algorithms, that perform Internet Protocol Security (IPsec) on data units as needed for a given security association (e.g., encryption, decryption, authentication, encapsulation).

### Exemplary High-Level System Diagram

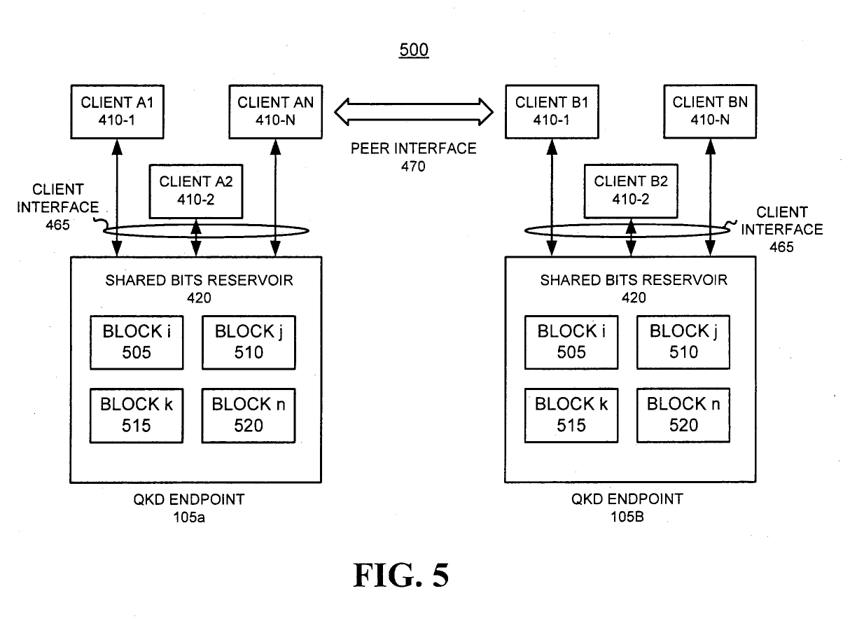

FIG. 5 is an exemplary high-level system diagram, consistent with the present invention, that illustrates client selection and retrieval of secret bit values from shared bits reservoir 420 at each QKD endpoint 105a and 105b that is party to an encryption key exchange via QKD. Each QKD endpoint 105 may include one or more clients 410-1 through 410-N coupled to a shared bits reservoir 420 via a client interface 465. Shared bits reservoir 420 may include multiple blocks of secret bit values stored in one or more memory devices, such as memory 210 (FIG. 2). Each block may contain a series of secret bit values. The block of the multiple blocks may be organized into fixed-size or variable-size blocks. Blocks i 505, j 510, k 515 and n 520 are shown by way of example, though more or fewer numbers of blocks may be present in shared bits reservoir 420. An identification of a selected block of secret bits at one QKD endpoint 105a may be sent, via peer interface 470, to another QKD endpoint 105b. The selected block of secret bits may, for example, then be used for encrypting traffic sent via network 110 between QKD endpoint 105a and QKD endpoint 105b.

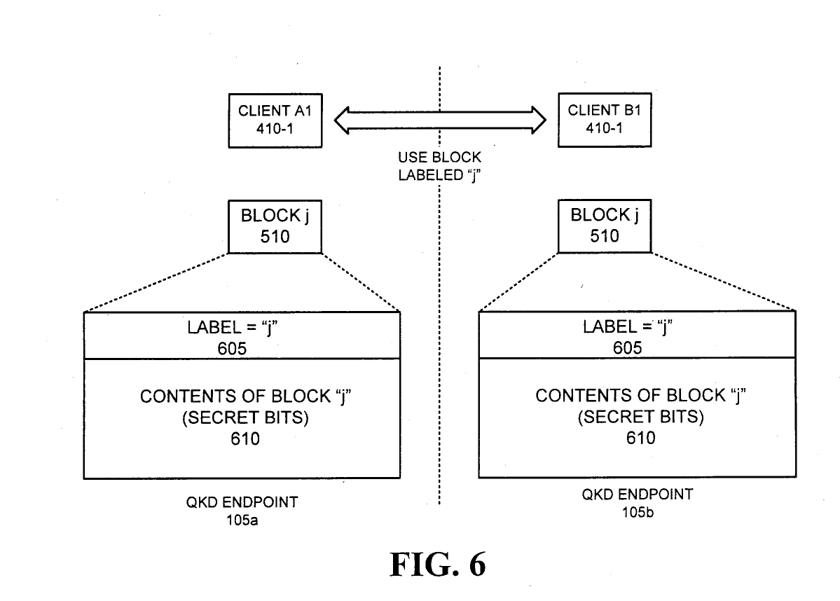

As an example, FIG. 6 illustrates exemplary details of the identification of block j 510 of shared bits reservoir 520 at QKD endpoints 105a and 105b. QKD endpoint 105a may identify block j 510 as the current block of secret bit values to be used by QKD endpoint 105b. As shown in FIG. 6, block j 510 may include a label 605 and contents 610. Label 605 may uniquely identify the associated block of secret bit values. Label 605 may be sent from QKD endpoint 105a to QKD endpoint 105b for identifying the block of secret bits values to be used. Label 605 may include any type of value for identifying the associated block, including, (but not limited to) a sequence number, time stamp, and/or textual string. Contents 610 may include a series of secret bit values that may be used, for example, for cryptographically protecting (e.g., encrypting, decrypting, authentication, etc.) traffic sent between QKD endpoint 105a and QKD endpoint 105b.

### Exemplary Master Initiated Shared Secret Arbitration

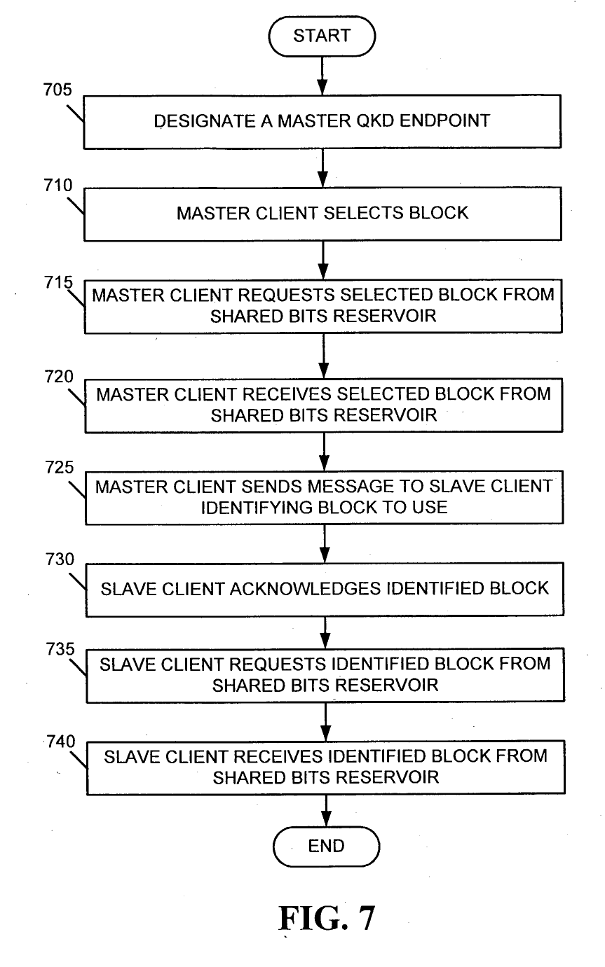

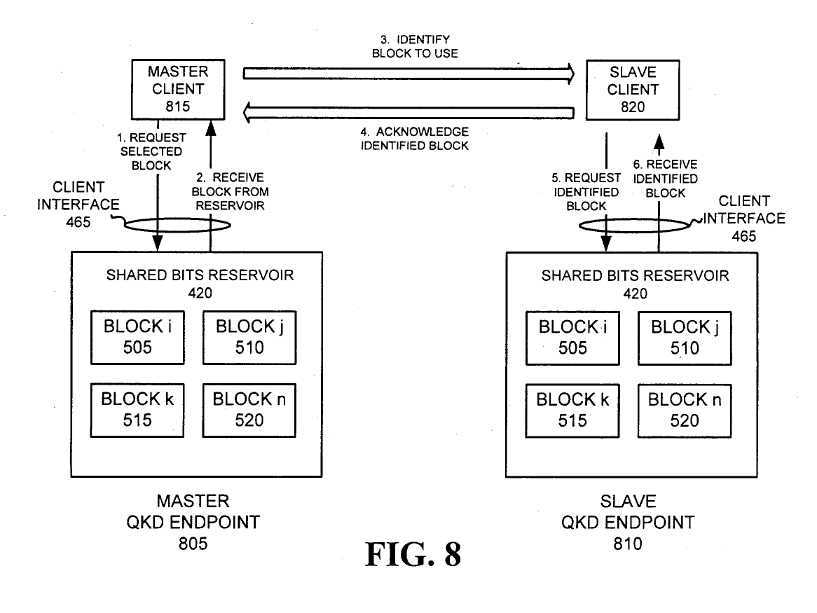

FIG. 7 is a flowchart that illustrates a master client initiated shared secret arbitration process consistent with the present invention. As one skilled in the art will appreciate, the method exemplified by FIG. 7 can be implemented as a sequence of instructions and stored in memories 210 of QKD endpoints 105 for execution by corresponding processing units 205. The exemplary process of FIG. 7 is further graphically illustrated with respect to FIG. 8.

The exemplary QKD shared secret arbitration response process may begin with the designation of a QKD endpoint 105 of network 100 as a master QKD endpoint 805 (FIG. 8) [act 705]. This designation may be done by configuration prior to endpoint operation, on the basis of equipment present in a QKD endpoint 105 (e.g., a QKD endpoint with a laser may always be the master), by distributed algorithms (e.g., picking the smallest Internet Protocol (IP) address, voting algorithms, etc.), or based on actions directed by a centralized or distributed network management system. A client of the selected master QKD endpoint 805 acts as the master client 815 and may select a block of bits in its local shared bits reservoir 420 [act 710]. Master client 815 of master QKD endpoint 805 may then request the selected block of bits from shared bits reservoir 420 [act 715](see “1,” FIG. 8). Master client 815 may receive the requested block from its shared bits reservoir 420 [act 720] (see “2,” FIG. 8). Master client 815 may then send a message to a slave client 820 in a slave QKD endpoint 810 identifying the block to use [act 725](see “3,” FIG. 8). Slave client 820 of slave QKD endpoint 810 may receive the message and acknowledge the block identified by master client 815 [act 730](see “4,” FIG. 8). Slave client 820 may then request the identified block from its own local shared bits reservoir 420 [act 735](see “5,” FIG. 8). Slave client 820 of slave QKD endpoint 810 may receive the requested block from its local shared bits reservoir 420 [act 740](see “6,” FIG. 8). After receipt of the requested block, slave client 820 may use the block to, for example, set up a security association (e.g., for cryptographically protecting traffic sent between the master and slave clients, such as, for example, encrypting, decrypting, authentication and the like). In another implementation, slave client 820 may use the block of secret bits as a seed in a deterministic function, such as, for example, a pseudo-random generator.

### Exemplary Slave Initiated Shared Secret Arbitration

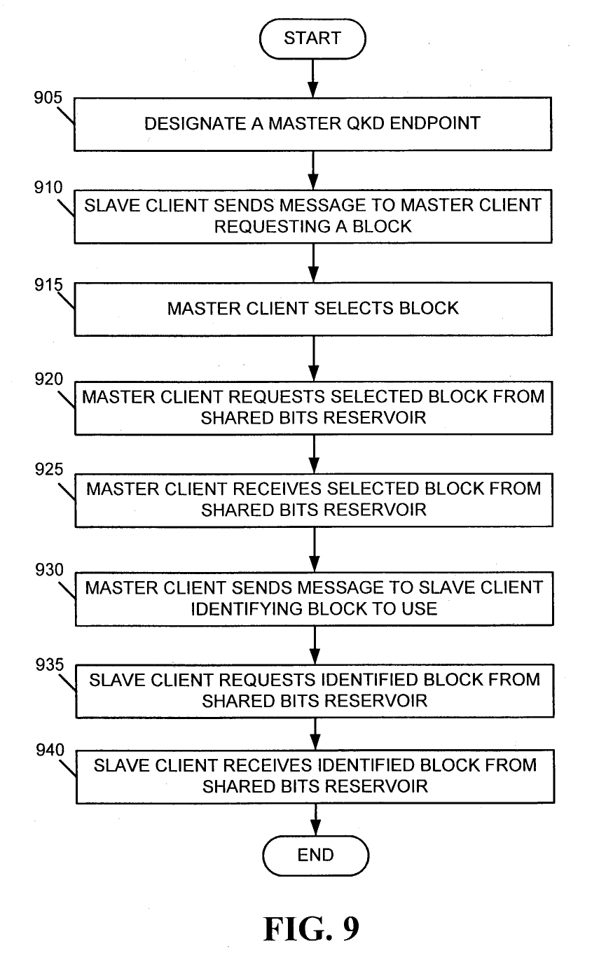

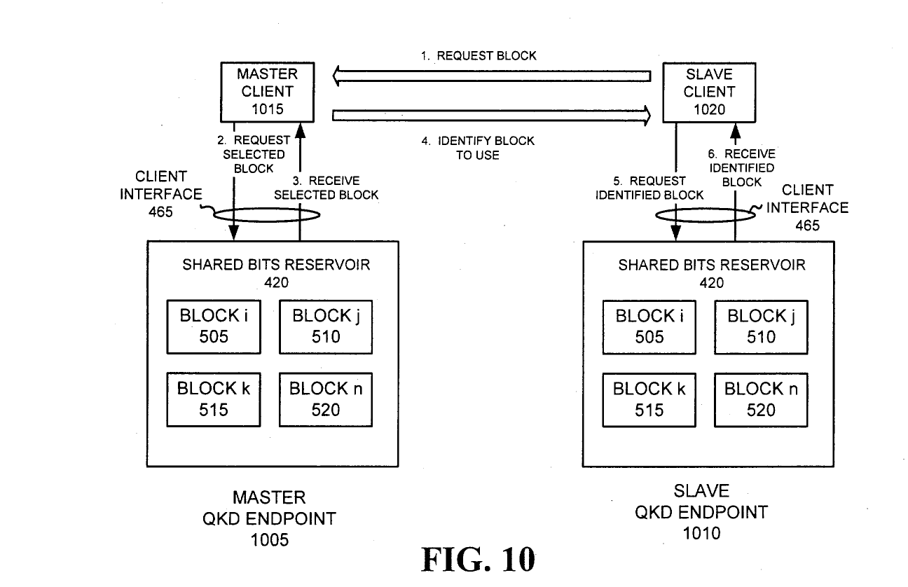

FIG. 9 is a flowchart that illustrates a slave client initiated shared secret arbitration process consistent with the present invention. As one skilled in the art will appreciate, the method exemplified by FIG. 9 can be implemented as a sequence of instructions and stored in memories 210 of QKD endpoints 105 for execution by corresponding processing units 205. The exemplary process of FIG. 9 is further graphically illustrated with respect to FIG. 10.

The exemplary arbitration process may begin with the designation of a QKD endpoint 105 of network 100 as a master QKD endpoint 1005 (FIG. 10) [act 905]. This designation may be done by configuration, on the basis of equipment present in a QKD endpoint 105 (e.g., a QKD endpoint with a laser may always be the master), by distributed algorithms (e.g., picking the smallest Internet Protocol (IP) address, voting algorithms, etc.), or based on actions directed by a centralized or distributed network management system. A slave client 1020 of a slave QKD endpoint 1010 may send a message to master client 1015 of master QKD endpoint 1005 requesting a block of secret bits [act 910](see “1,” FIG. 10). Master client 1015 may receive the request and select a block from its local shared bits reservoir 420 [act 915]. Master client 1015 may then request the selected block from the local shared bits reservoir 420 [act 920](see “2,” FIG. 10). In response to the request, master client 1015 may receive the requested block from its local shared bits reservoir 420 [act 925](see “3,” FIG. 10). Master client 1015 may then send a message to slave client 1020 identifying the block to use [act 930](see “4,” FIG. 10). Slave client 1020 may receive the message and request the identified block from its own local shared bits reservoir 420 [act 935](see “5,” FIG. 10). Slave client 1020 may receive the identified block from its local shared bits reservoir 420 [act 940] (see “6,” FIG. 10). After receipt of the requested block, slave client 1020 may use the block to, for example, set up a security association (e.g., for cryptographically protecting traffic sent between the master and slave clients, such as, for example, encrypting, decrypting, authentication and the like). In another implementation, slave client 1020 may use the block of secret bits as a seed in a deterministic function, such as, for example, a pseudo-random generator.

### Conclusion

Systems and methods consistent with the present invention control the allocation of shared secret symbols resulting from quantum cryptographic key distribution (QKD) between multiple QKD endpoints in a QKD system, such as the QKD system disclosed in co-pending U.S. patent application Ser. No. 09/943,709, entitled “Systems and Methods for Path Set-up in a Quantum Key Distribution Network,” and U.S. patent application Ser. No. 09/944,328, entitled “Quantum Cryptographic Key Distribution Networks with Untrusted Switches.” Systems and methods consistent with the invention alleviate contention and deadlock problems that may result from clients at QKD endpoints vying for the same shared secret bits through the implementation of processes for arbitrating access to the shared secret bits.

The foregoing description of embodiments of the present invention provides illustration and description, but is not intended to be exhaustive or to limit the invention to the precise form disclosed. Modifications and variations are possible in light of the above teachings or may be acquired from practice of the invention. For example, while certain aspects of the invention have been described as implemented in software, hardware (e.g., field programmable gate arrays (FPGAs)), firmware, or other hardware/software configurations may be used. While series of acts have been described in FIGS. 7 and 9, the order of the acts may vary in other implementations consistent with the present invention. Also, non-dependent acts may be performed in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A method of arbitrating selection of shared secret bits between a plurality of quantum cryptographic key distribution (QKD) devices, comprising:
designating one of the QKD devices as a master device and at least one of the other of the plurality of QKD devices as a slave device;
selecting a block of the shared secret bits at the master device; and
notifying the slave device of the selected block of the shared secret bits.

2. The method of claim 1, wherein the shared secret bits have been agreed upon by the master device and the slave device using one or more quantum cryptographic techniques.

3. The method of claim 1, wherein designating one of the QKD devices as a master device and at least one of the other of the plurality of QKD devices as a slave device comprises:
configuring, prior to operation, the one of the QKD devices as a master device and the at least one of the other of the plurality of QKD devices as a slave device.

4. The method of claim 1, wherein designating one of the QKD devices as a master device and at least one of the other of the plurality of QKD devices as a slave device comprises:
performing a distributed algorithm at the one of the QKD devices and the at least one of the other of the plurality of QKD devices to designate the one of the QKD devices as a master device and the at least one of the other of the plurality of QKD devices as a slave device

5. The method of claim 1, wherein the one of the QKD devices is designated as a master device and the at least one of the other of the plurality of QKD devices is designated as a slave device based on equipment present in the one of the QKD devices and the at least one of the other of the plurality of QKD devices.

6. The method of claim 1, wherein the one of the QKD devices is designated as a master device and the at least one of the other of the plurality of QKD devices is designated as a slave device based on actions directed by at least one of a centralized network management system and a distributed network management system.

7. The method of claim 1, further comprising:
retrieving the selected block of the shared secret bits from a memory.

8. The method of claim 7, further comprising:
using the selected block of the shared secret bits for cryptographically protecting data sent between the master device and the slave device.

9. The method of claim 1, further comprising:
sending a message from the slave device to the master device acknowledging the selected block of the shared secret bits.

10. The method of claim 7, further comprising:
using the selected block of the shared secret bits for generating a pseudo-random number sequence.

11. A quantum cryptographic key distribution system, comprising:
a first quantum cryptographic device designated as a slave device and configured to store shared secret data; and
a second quantum cryptographic device designated as a master device and configured to:
select a block of the shared secret data, and
notify the slave device of the selected block of the shared secret data.

12. A computer-readable medium containing instructions for controlling at least one processor to perform a method of arbitrating selection of shared secret bits between a plurality of quantum cryptographic key distribution (QKD) devices, the method comprising:
designating one of the QKD devices as a master device and at least one of the other of the plurality of QKD devices as a slave device;
selecting a block of the shared secret bits, wherein the shared secret bits have been transmitted between the master device and the slave device using one or more quantum cryptographic techniques;
notifying the slave device of the selected block of the shared secret bits; and
cryptographically protecting data sent between the master device and the slave device using the selected block of the shared secret bits.

13. A system for arbitrating selection of shared secret bits between a plurality of quantum cryptographic key distribution (QKD) devices, comprising:
means for designating one of the QKD devices as a master device and at least one of the other of the plurality of QKD devices as a slave device;
means for selecting a block of the shared secret bits at the master device; and
means for notifying the slave device of the selected block of the shared secret bits.

14. A method of allocating shared secret data at a plurality of devices, comprising:
selecting a block of the shared secret data at a first of the plurality of devices;
sending an identifier of the selected block to a second of the plurality of devices; and
allocating the selected block at the first and second of the plurality of devices for use in cryptographically protecting data sent between the first and second of the plurality of devices.

15. The method of claim 14, wherein the plurality of devices comprise quantum cryptographic key distribution devices.

16. The method of claim 15, wherein the shared secret data has been agreed upon by the first and second of the plurality of quantum cryptographic key distribution devices using one or more quantum cryptographic techniques.

17. The method of claim 14, further comprising:
designating the first of the plurality of devices as a master device and the second of the plurality of devices as a slave device.

18. The method of claim 17, wherein designating the first of the plurality of devices as a master device and the second of the plurality of devices as a slave device comprises:
configuring, prior to operation, the first of the plurality of devices as a master device and the second of the plurality of devices as a slave device.

19. The method of claim 17, wherein designating the first of the plurality of devices as a master device and the second of the plurality of devices as a slave device comprises:
performing a distributed algorithm at the first and second of the plurality of devices to identify the first of the plurality of devices as a master device and the second of the plurality of devices as a slave device.

20. The method of claim 17, wherein the first of the plurality of devices is designated as a master device and the second of the plurality of devices is designated as a slave device based on equipment present in the first and second plurality of devices.

21. The method of claim 17, wherein the first of the plurality of devices is designated as a master device and the second of the plurality of devices is designated as a slave device based on actions directed by at least one of a centralized network management system and a distributed network management system.

22. A system for allocating shared secret bits at a plurality of quantum cryptographic key distribution devices, comprising:
a first quantum cryptographic device configured to:
select a block of the shared secret bits, and
send an identifier of the selected block to a second of the plurality of devices; and
the second quantum cryptographic device configured to:
retrieve the selected block for use in cryptographically protecting data sent between the second quantum cryptographic device and the first quantum cryptographic device.

23. A computer-readable medium containing instructions for controlling at least one processor to perform a method of allocating shared secret bits at a first quantum

23. A computer-readable medium containing instructions for controlling at least one processor to perform a method of allocating shared secret bits at a first quantum cryptographic key distribution device of a plurality of quantum cryptographic key distribution devices, the method comprising:
selecting a block of the shared secret bits;
sending an identifier of the selected block to a second of the plurality of quantum cryptographic key distribution devices; and
retrieving the selected block for use in cryptographically protecting data sent between the first and second of the plurality of quantum cryptographic key distribution devices.

24. A data structure encoded on a computer readable medium, comprising:
first data comprising a first block of secret bits transmitted via one or more quantum cryptographic techniques;
second data comprising a first label identifying the first block of secret bits;
third data comprising a second block of secret bits transmitted via the one or more quantum cryptographic techniques; and
fourth data comprising a second label identifying the second block of secret bits.

25. The data structure of claim 24, wherein the first and second labels comprise at least one of a sequence number, a time stamp, and a textual string.

26. The data structure of claim 24, wherein each of the first and second blocks of secret bits comprise at least one of a fixed-size block and a variable size block of secret bits.

27. The data structure of claim 24, further comprising:
fifth data comprising a third block of secret bits transmitted via the one or more quantum cryptographic techniques; and
sixth data comprising a third label identifying the third block of secret bits.

28. The data structure of claim 27, wherein the first, second, third and fourth data are stored in a first reservoir associated with a first quantum cryptographic peer.

29. The data structure of claim 28, wherein the fifth and sixth data are stored in a second reservoir associated with a second quantum cryptographic peer.
